(19) United States
(12) Patent Application Publication
(10) Pub. No.: US 2014/0280385 A1
(43) Pub. Date: Sep. 18, 2014

(54) HIERARCHICAL INTERSECTIONS

(71) Applicant: MetaPower, Inc., Vancouver, WA (US)

(72) Inventors: John Prouty, Portland, OR (US); Kenneth R. Allen, Vancouver, WA (US)

(21) Appl. No.: 13/853,892

(22) Filed: Mar. 29, 2013

Related U.S. Application Data
(60) Provisional application No. 61/784,153, filed on Mar. 14, 2013.

(51) Int. Cl. G06F 17/30

(52) U.S. Cl. CPC G06F 17/30339
USPC 707/812

(57) ABSTRACT

A computer can include memory, which can include a database. The database can include a base, and instances of the base. The instances of the base can be organized into a hierarchy. Hierarchical intersections can be used to represent the hierarchy of the instances of the base. When the hierarchy is modified, the hierarchical intersections can be duplicated, and the duplicates modified, to reflect the change in the hierarchy.

### RELATED APPLICATION DATA

This application claims the benefit of U.S. Provisional Patent Application Ser. No. 61/784,153, filed Mar. 14, 2013, titled “Hierarchical Intersections”, which is incorporated by reference herein for all purposes.

### FIELD OF THE INVENTION

This invention pertains to a computerized method and database for process design, and more particularly to managing a hierarchy of elements in the database.

### BACKGROUND OF THE INVENTION

Databases can be used to manage various pieces of information. For example, databases can be used to track all the employees of the company, how the company is structured, the equipment owned by the company, and so on. Databases also can be used to correlate information across various tables. For example, a properly structured database can determine, for a given employee, what department that employee works for.

But when information becomes hierarchical, traditional databases are not ideal. Databases can store information about an entity's immediate parent(s), and careful use of recursion can be used to divine answers to some questions from the database. For example, the database can be used to identify an employee's managers, or to determine which employee is at the top of the hierarchy. But there are other questions that a traditional database, even using recursion, simply cannot answer. For example, the database cannot be used to determine which employees are at the bottom of the hierarchy, or even what children a particular entity has. The problem becomes even more complicated when revisions of the data are also stored in the database.

The present invention addresses these and other problems associated with the prior art.

### SUMMARY OF THE INVENTION

A computer can store a database. The database can include a base. Instances of this base, representing various revisions of the instance of the base, can also be stored in the database. Hierarchical intersections can be used to represent a hierarchy of the instances of the base. When an instance of the base in the hierarchy is modified, the hierarchical intersections can be duplicated, with a hierarchical intersection being modified to reflect the change made to the instance of the base.

The foregoing and other features, objects, and advantages of the invention will become more readily apparent from the following detailed description, which proceeds with reference to the accompanying drawings.

### BRIEF DESCRIPTION OF THE DRAWINGS

FIGS. 1A-1B show two hierarchies of base instances.

FIG. 2 shows a system that can manage a hierarchy of base instances, such as those shown in FIGS. 1A-1B, according to an embodiment of the invention.

FIG. 3 shows details of the database of FIG. 2 that can manage hierarchies of base instances.

FIGS. 4-16 show the development of a hierarchy of base instances and their representation using hierarchical intersections in the system of FIG. 2.

FIGS. 17-18 show the hierarchies of base instances of FIGS. 7 and 15 in a tree diagram.

FIG. 19 shows a flowchart of a procedure for managing a hierarchy of base instances using hierarchical intersections in the system of FIG. 2, according to an embodiment of the invention.

FIGS. 20A-20C show details of how a duplicated hierarchical intersection can be modified in the flowchart of FIG. 19, depending on the change made to the hierarchy of base instances.

FIG. 21 shows details of how duplicated hierarchical intersections can be deleted if no hierarchical intersections representing a hierarchy of instances has its applicability indicator set, according to an embodiment of the invention.

### DETAILED DESCRIPTION OF THE PREFERRED EMBODIMENT

Before how embodiments of the invention can be used to manage a hierarchy of instances of a base, an example of what such a hierarchy might represent is in order. The concepts of archetypes, type, instances, and revisions are drawn from U.S. Pat. No. 6,768,984, issued Jul. 27, 2004, titled “METHOD AND APPARATUS FOR PROCESS DESIGN”, U.S. Pat. No. 7,254,954, issued Aug. 7, 2007, titled “METHOD AND APPARATUS FOR PROCESS DESIGN”, U.S. Pat. No. 7,756,914, issued Jul. 13, 2010, titled “METHOD AND APPARATUS FOR PROCESS DESIGN”, U.S. Pat. No. 7,945,599, issued May 17, 2011, titled “METHOD AND APPARATUS FOR PROCESS DESIGN”, all of which are incorporated by reference herein for all purposes.

To summarize, archetypes are akin to templates that can be used to generate data-storing models (called types) and objects (called instances). A base is an example of an archetype: other archetypes include controls, intersections, observations, generators, and accumulators. Or, put another way, archetypes are used to classify data objects at the highest level of the process design. Types, on the other hand, represent models from which individual data objects can be created to store data. Instances represent logical occurrences of individual types. Finally, revisions are created for instances and actually store the data. It may help to consider the hierarchy from the bottom up: revisions store data, instances identify data objects, types define classes of instances with common themes, and archetypes define classes of types (a meta-type). As with U.S. Pat. No. 6,768,984, issued Jul. 27, 2004, titled “METHOD AND APPARATUS FOR PROCESS DESIGN”, U.S. Pat. No. 7,254,954, issued Aug. 7, 2007, titled “METHOD AND APPARATUS FOR PROCESS DESIGN”, U.S. Pat. No. 7,756,914, issued Jul. 13, 2010, titled “METHOD AND APPARATUS FOR PROCESS DESIGN”, and U.S. Pat. No. 7,945,599, issued May 17, 2011, titled “METHOD AND APPARATUS FOR PROCESS DESIGN”, in general context will distinguish the concepts of archetype, type, and instance.

Turning now to FIG. 1A, hierarchy 105 of base instances is shown. In FIG. 1A, the top of hierarchy 105 includes logical key 0 (110). Below instance 110 in hierarchy 105 are three other instances: these are logical key 1.0 (115), logical key 2.0 (120), and logical key 3.0 (125).

In FIG. 1B, hierarchy 130 is similar to hierarchy 105, except that new logical key 1.1 (135) has been added. Logical key 1.1 (135) is has instance 115 as its parent node in hierarchy 130.

Hierarchies 105 and 130 can be hierarchies representing a company's organizational structure, an equipment breakdown structure, or performance indicators, among other possibilities. A person skilled in the art will recognize other possible uses for hierarchies 105 and 130.

Traditionally, hierarchies are represented using tables that use a key in the table that references itself recursively, identifying a node's parent in the hierarchy. This type of database model can represent a hierarchy. But the representation is awkward because of its recursive nature, and there are limits to the questions that can be asked of the database. For example, such a database can identify, for a given node in the hierarchy, what nodes are above that node in the hierarchy. Using FIG. 1B, given logical key 1.1 (135), a standard database model can identify logical key 1.0 (115) and logical key 0 (110) as its ancestors. And there are other questions—Given a node in the hierarchy, what nodes are descendants of that node? What nodes are leaf nodes in the hierarchy?—that a recursive representation cannot answer easily, if at all.

In addition, traditional representations of hierarchies cannot add future revisions to the hierarchy, nor can they add new hierarchies without changing the table storing the data. For example, traditional representations of hierarchies cannot include a single node in more than one hierarchy. Or put another way, given a particular database design, there is a pre-determined limit to the number of hierarchies that can include a given node, which limit might be insufficient for a particular customer's needs.

Thus, it is desirable to find a way to represent a hierarchy that can address these problems. Further, it is desirable to represent hierarchies without relying on the self-referential aspects of traditional database designs.

While the above discussion focuses on a hierarchy of instances of a base type, a person skilled in the art will recognize that hierarchies 105 and 130 can represent instances of any archetype. While the discussion below focuses on a hierarchy of instances of a base, a person skilled in the art will recognize how embodiments of the invention can be modified to work with instances of any other archetype.

Turning now to embodiments of the claimed invention, FIG. 2 shows a system that can manage a hierarchy of base instances, such as those shown in FIGS. 1A-1B, according to an embodiment of the invention. In FIG. 2, computer system 205 is shown. Computer system 205 conventionally includes a computer 210, a monitor 215, a keyboard 220, and a mouse 225. Optional equipment not shown in FIG. 2 can include a printer and other input/output devices. Also not shown in FIG. 2 are the conventional internal components of computer system 205: e.g., a central processing unit, memory, file system, etc.

Computer system 205 includes database 230 and modifier 235. Database 230 can store process design information, as described in U.S. Pat. No. 6,768,984, issued Jul. 27, 2004, titled “METHOD AND APPARATUS FOR PROCESS DESIGN”, U.S. Pat. No. 7,254,954, issued Aug. 7, 2007, titled “METHOD AND APPARATUS FOR PROCESS DESIGN”, U.S. Pat. No. 7,756,914, issued Jul. 13, 2010, titled “METHOD AND APPARATUS FOR PROCESS DESIGN”, and U.S. Pat. No. 7,945,599, issued May 17, 2011, titled “METHOD AND APPARATUS FOR PROCESS DESIGN”, but modified to also store hierarchical intersections, as discussed below. Modifier 235 can modify the hierarchical intersections to represent a change made to the hierarchy of instances.

While FIG. 2 suggests that computer system 205 is a standard computer system, such as a person computer, computer system 205 can be replaced with any other viable computer system. Thus, for example, computer system 205 can be a server, hosted on a local network or accessible via the Internet from another computer. In addition, any viable computer system can access data from database 230 including, for example, a notebook computer, a tablet computer, or a smartphone, among other possibilities.

FIG. 3 shows details of the database of FIG. 2 that can manage hierarchies of base instances. In FIG. 3, database 230 stores base type 305, instances 310 of base type 305, and hierarchical intersections 315. While FIG. 3 shows only one base type 305 and one base instance 310, a person of ordinary skill in the art will recognize that there are potentially multiple different base types and multiple instances of each base stored in database 230. In a similar manner, there can be any number of hierarchical intersections 315 stored in database 230.

Hierarchical intersections 315 enable the database to construct a hierarchy of base instances, and manage that hierarchy. Whereas a static intersection (as described in U.S. Pat. No. 6,768,984, issued Jul. 27, 2004, titled “METHOD AND APPARATUS FOR PROCESS DESIGN”, U.S. Pat. No. 7,254,954, issued Aug. 7, 2007, titled “METHOD AND APPARATUS FOR PROCESS DESIGN”, U.S. Pat. No. 7,756,914, issued Jul. 13, 2010, titled “METHOD AND APPARATUS FOR PROCESS DESIGN”, and U.S. Pat. No. 7,945,599, issued May 17, 2011, titled “METHOD AND APPARATUS FOR PROCESS DESIGN”) correlates two different base instances, hierarchical intersection 315 correlates two different logical keys of the same base instance. How this correlation works is easiest explained with reference to FIGS. 4-16.

FIG. 4 shows the creation of new hierarchy 405. Hierarchy 405 consists of a single base 410, which is controlled by control 415. The information stored in base 410 specifies the instance ID and physical key of the base (the top row of information in base 410), a logical key (the middle row of information in base 410), the control type for the base, the control ID, the revision number of the base, and the revision status of the base (the bottom row of information in base 410). Thus, base 410 has an ID of 15, a reference number of 10, a logical key of 0, is controlled by a Control instance with the ID of 1, is revision number 0 of the base, and is a Future revision of the base.

Similarly, the information stored in control instance 415 specifies the instance ID and physical key of the control (the top row of information in control 415), a revision number (the middle row of information in control 415), and the revision status of the control (the bottom row of information in control 415). Thus, control 415 has an ID of 1, a reference number of 1, a revision number of 0, and is a Future revision of the control.

Because hierarchy 405 only has one base instance, hierarchy 405 is still a trivial hierarchy, and therefore can be represented without using any hierarchical intersections. Thus, representation 420 includes no hierarchical intersections. But when a second base instance is added to hierarchy 405, hierarchy 405 becomes more complex. This is shown in FIG. 5.

In FIG. 5, base 505, controlled via control 510, has been added to hierarchy 405. Base 505 has a logical key of 1.0, and is created as a child of base 410. As hierarchy 405 now includes two bases, hierarchy 405 is more complicated, and hierarchical intersections are used in representation 420. Two hierarchical intersections 515 and 520 are created to represent hierarchy 405.

As with bases and controls, the information stored in hierarchical intersections 515 and 520 helps to specify the function of the hierarchical intersection. The information stored in a hierarchical intersection includes the parent key—that is, the logical key of the base that is the parent in hierarchy 405—(the top row of information in hierarchical intersections 515 and 520), the revision status of the parent in hierarchy 405 (the second row of information in hierarchical intersections 515 and 520), the left visit number, visit ID, and right visit number of the hierarchical intersection (the third row of information in hierarchical intersections 515 and 520), the revision status of the child in hierarchy 405 and the revision applicability indicator (the fourth row of information in hierarchical intersections 515 and 520), and the child key—that is, the logical key of the base that is the child in hierarchy 405—(the bottom row of information in hierarchical intersections 515 and 520).

Some explanation about the data stored in hierarchical intersections 515 and 520 is worth understanding. The parent and child keys identify the parent and child bases in hierarchy 405: that is, for a given parent/child pair, these keys identify which base is closer to the root of hierarchy 405 and which base is farther from the root of hierarchy 405. As there are only two bases in hierarchy 405 at this time, there is no confusion about which base is the root of hierarchy 405 and which base is the leaf node of hierarchy 405. But as hierarchy 405 becomes more complex, the ability to identify which base is the parent and which base is the child for a given hierarchical intersection becomes more significant.

For convenience, the visit ID assigned to hierarchical intersections in a representation of a hierarchy is the physical key of the base being added to the hierarchy. All hierarchical intersections in that representation of hierarchy 405 are assigned the same visit ID, which makes it simple to identify which hierarchical intersections belong to a particular representation of a hierarchy (as will be described below with reference to FIGS. 8-16, there can be multiple different representations of a hierarchy as changes are made to the hierarchy). Thus, since base 505, with physical key 20, was added to hierarchy 405, the visit IDs for hierarchical intersections 515 and 520 are set to 20.

The left visit and right visit numbers track the construction of the representation of the hierarchy. The easiest way to think about the values of the visit numbers is to consider a depth first search of the representation of the hierarchy. The first time the depth first search passes through a hierarchical intersection, the left visit number is assigned the next consecutive value. The second time the depth first search passes through the hierarchical intersection, the right visit number is assigned the next consecutive value. Thus, in FIG. 5, hierarchical intersection 515 gets the left visit number of 1, then hierarchical intersection 520 gets the left visit number of 2, then (since base 505 is the leaf of hierarchy 405) hierarchical intersection 520 gets the right visit number of 3, and then hierarchical intersection 515 gets the right visit number of 4.

The revision applicability indicator indicates whether the hierarchical intersection affects a revised instance of the child instance. The possible values are Yes or No. The significance of the applicability indicator is that the applicability indicator lets the system know when the hierarchy includes a change in the structure. Another possible name for the applicability indicator could be a “base revised indicator”. A person of ordinary skill in the art will recognize that the name of this indicator (or any other term, for that matter) is less important than the function the structure provides.

To help explain the significance of the applicability indicator, consider the creation of a new hierarchy by the addition of a new instance to an older hierarchy. If the new next action would be to delete the newly created instance, then the new hierarchy would end up identical to the older hierarchy. As such, the modified new hierarchy could be deleted, without any loss of information.

Identifying such a situation is the purpose of the applicability indicator. After a hierarchy is modified in some way, if all the hierarchical intersections have their applicability indicators set to No, then the hierarchy is no longer needed, and can be safely deleted. In computer parlance, the applicability indicator can be said to enable garbage collection.

The reason a hierarchy can be deleted if no hierarchical intersections have their applicability indicators set is that the hierarchy cannot become current. If no hierarchical intersections have their applicability indicators set, then no instance in the hierarchy is a future instance. But if no instance in the hierarchy is a future instance, then the hierarchy will never become current at some point in the future (although the hierarchy might be current now or have been current at some point in the past). And if the hierarchy will never become current in the future, it is unneeded.

Typically, the modifications that could result in deletion of an unneeded hierarchy (all the hierarchical intersections in the hierarchy have their applicability indicators set to No) involve deleting an instance from the hierarchy. But there is no reason to limit checks of the applicability indicator only to situations where an instance is being removed from a hierarchy, in case other modifications might also result in a hierarchy that is no longer needed.

A person skilled in the art might wonder why two hierarchical intersections 515 and 520 are created in FIG. 5, when there are only two bases in hierarchy 405. It is true that if the database can store somewhere that base 410 is the root of the tree forming hierarchy 405, then only one hierarchical intersection would be needed. However, creating two hierarchical intersections at this time has some advantages. First, the database does not need to store somewhere that base 410 is the root of hierarchy 405: this information is conveyed by the fact that the parent key in hierarchical intersection 515 has value 0. Since there is no base with a physical key of 0 stored in the database, the hierarchical intersection that has a parent key of 0 identifies its child as the root of hierarchy 405.

A second advantage of creating a hierarchical intersection with a parent key of 0 is that every base in hierarchy 405 is identified as a child key in some hierarchical intersection in the representation. This means that every base in the representation can be located simply by identifying all child keys in the hierarchical intersections in the representation. If hierarchical intersection 515 was not created, a special case would be needed to identify base 410 as part of the representation.

Turning now to FIG. 6, a new base 605, controlled by control 610, is shown. This base has a logical key of 1.1, and is a child of base 505. Thus, new hierarchical intersection 615 is created to represent the parent/child relationship between bases 505 and 605. Note that the left and right visit numbers change in many hierarchical intersections as a result of the creation of the new hierarchical intersection.

The addition of base 605 is, of course, a modification of hierarchy 405. As with all such modifications, representation 420 can be duplicated, to distinguish between the representations before and after the addition of base 605. But when multiple bases are being added to the hierarchy, the new bases can all be added as part of the same representation, without loss of information. Thus, rather than duplicating representation 420 when base 605 is added, base 605 is added to representation 420. Note also that hierarchical intersection 615 is also assigned visit ID 20, as with the other hierarchical intersections in representation 420.

In FIG. 7, a new base 705, controlled by control 710, is shown. This base has a logical key of 2.0, and is a child of base 410. Thus, new hierarchical intersection 715 is created to represent the parent/child relationship between bases 410 and 705. Note again that the left and right visit numbers change in many hierarchical intersections as a result of the creation of the new hierarchical intersection.

FIG. 8 represents the first time hierarchy 405 is changed without adding a new base to hierarchy 405. In FIG. 8, base 410 is marked as complete. Thus, when base 410 is changed to base 805 (with new control 810) and marked as Current (as opposed to being a future base), representation 420 is duplicated as representation 815, and hierarchical intersection 820 is modified to reflect the Current status of base 805. Note that hierarchical intersection 820, along with hierarchical intersections 825, 830, and 835, are modified to use a new visit ID. As new base 805 is assigned physical key 50, this value becomes the new visit ID for all the hierarchical intersections in representation 815. Note also that hierarchical intersection 820 (along with hierarchical intersections 825 and 835) have their revision status of the parent set to Current, as base 805 now has Current status. Hierarchical intersection 820 also has its revision status of the child set to Current, as base 805 (the child of hierarchical intersection 820) has Current status.

Some of the hierarchical intersections in representation 420 are also modified. With the exception of the revision status of the child in hierarchical intersection 515, the revision statuses of hierarchical intersections 515, 520, 615, and 715 are all set to Control, to represent that they are no longer applicable to their respective bases. This fact is also represented by the dashed lines for hierarchical intersections 520, 615, and 715. And because hierarchical intersections 520, 615, and 715 are being assigned Control revision status, these hierarchical intersections no longer apply to their bases, so their revision applicability indicator is set to No.

In FIG. 9, base 505 is routed to completion. The process is similar to that described for FIG. 8. New base 905, with control 910, is created and marked as Current. Base 505 is marked as Control. Representation 815 is duplicated as representation 915, with new hierarchical intersections 920, 925, 930, and 935 being created. Hierarchical intersection 925 has the revision status of its child set to Current because the child base of hierarchical intersection 925 is marked as Current. And all hierarchical intersections 920, 925, 930, and 935 have the visit ID of 60, because that is the physical key of new base 905.

For reasons of space, FIG. 9 does not show representation 420. Similarly, for reasons of clarify, base 410 and control 415 are not shown in FIG. 9. But despite their omission from FIG. 9, these objects are still part of the database. Going forward, only those elements necessary for a particular drawing will be shown, but the omission of other elements from a drawing should not be interpreted as indicating that those elements are not present.

In FIG. 10, base 605 is routed to completion. As with FIGS. 8 and 9, new base 1005, with control 1010, is created, and marked as complete. Representation 915 is duplicated as representation 1015, including new hierarchical intersections 1020, 1025, 1030, and 1035, all assigned visit ID 70 (the physical key of new base 1005). Hierarchical intersection 1030 also has the revision status for its child set to Current.

In FIG. 11, a new revision of base 905 is created. This new revision is base 1105, controlled by control 1110. In contrast to FIG. 9 (where base 905 was created to reflect the completion of base 505), new base 1105 is a new revision of a completed base. Therefore, unlike base 905, new base 1105 (and new control 1110) is given Future revision status.

Representation 1015 is duplicated to create representation 1115, with new hierarchical intersections 1120, 1125, 1130, and 1135. All four new hierarchical intersections 1120, 1125, 1130, and 1135 are assigned Future revision status for both parent and child nodes.

Because new base 1105 is given Future revision status and no the duplicated hierarchical revision that has that base as a child node is marked as a Future revision, hierarchical intersection 1125 has its revision applicability indicator set to Yes. Hierarchical intersections 1120, 1130, and 1135 have their revision applicability indicators set to No. For this reason, hierarchical intersections 1120, 1130, and 1135 are shown with dotted lines, to reflect that these hierarchical intersections are not yet applicable to their base.

FIG. 12 is similar to FIG. 11, in that a Future revision of a completed base is being created. Thus, FIG. 12 shows the creation of new base 1205 and new control 1210. But unlike FIG. 11, representation 1115 has a hierarchical intersection that has its child revision status marked as Future: specifically, hierarchical intersection 1130 of FIG. 11. Thus, instead of duplicating representation 1115, hierarchical intersection 1130 is modified to reflect the creation of new base 1205. This is similar to how an existing representation was modified to reflect the creation of new bases in FIGS. 6-7, rather than duplicating the representation. But representation 1115 can be duplicated and modified, just as representation 420 could be duplicated in FIGS. 6-7 to reflect the creation of a new base.

The modification of hierarchical intersection 1130 is shown in FIG. 12 as hierarchical intersection 1215. Note that there are two differences between hierarchical intersections 1130 and 1215: hierarchical intersection 1215 refers to the physical key 90 of base 1205, and the revision applicability indicator of hierarchical intersection 1215 is set to Yes.

In FIG. 13, yet another Future revision of base 1105 is created. Thus, new base 1305, controlled by control 1310, are shown. But as base 1305 is a second future revision of base 1105 (recall that base 1205 in FIG. 12 is also a Future revision of base 1105), the creation of new base 1305 cannot be handled by just modifying existing hierarchical intersections 1125 and 1215: such a modification would erase information about Future revision 1205. Thus, the creation of new base 1305 requires duplicating representation 1015 as representation 1315. Representation 1015 is duplicated because it was the last representation that included the current revision of base 905 (base 1105 being a Future revision). Thus, representation 1315 includes hierarchical intersections 1320, 1325, 1330, and 1335. Hierarchical intersections 1320, 1325, 1330, and 1335 are assigned visit IDs of 100, corresponding to the physical key of base 1305, and are set to Future revision status for their parent and child bases. Hierarchical intersection 1325 also has its revision applicability indicator set to Yes.

In FIG. 14, control 1110 is used to modify base 1105 to remove its parent key. In other words, base 1105 is to be made the root of its hierarchy. As a result, base 805, which previously was the root of the hierarchy including base 1105, is no longer part of the hierarchy, and the hierarchical intersection that included base 805 as the parent and 1105 as the child is removed from representation 1115. This modification also changes the parent key of hierarchical intersection 1405 (formerly hierarchical intersection 1125 of FIG. 12) to 0, to reflect that base 1105 is now the root of its hierarchy.

In addition, because base 805 is no longer part of the hierarchy, this modification affects base 705. Previously, base 705 was a child of base 805 in the hierarchy. By removing base 805 from the hierarchy, any other bases in the hierarchy that were children of base 805 are orphaned. These bases can also be removed from the representation of the hierarchy, which explains why former hierarchical intersection 1135 (of FIG. 12) has been removed.

Finally, removing bases 805 and 705 changes the left and right visit numbers for the remaining hierarchical intersections. Thus, hierarchical intersections 1405 and 1215 have their left and right visit numbers changed to reflect the new structure of the hierarchy.

In FIG. 15, control 1210 changes the parent key of base 1205 to point to logical reference 0: that is, base 1205 is being made a child of base 805. As a result, representation 1315 is modified. The hierarchical intersection that formerly represented the parent/child relationship between base 1305 and 1205 (former hierarchical intersection 1330 of FIG. 13) is deleted, and new hierarchical intersection 1505 is created. (Alternatively, former hierarchical intersection 1330 of FIG. 13 could be directly modified into hierarchical intersection 1505.)

Representation 1315 is changed in two respects. First, hierarchical intersection 1505 reflects base 805 as its parent, rather than base 1305. This occurs because base 805 is already in a future hierarchy (via hierarchical intersection 1320). Second, the left and right visit numbers for hierarchical intersections 1510, 1505, and 1515 are modified to reflect the change in the hierarchy.

Not shown in FIG. 15 is that the change to the parent key of base 1205 leaves base 1105 alone in its hierarchy (as shown in FIG. 14 above). Because base 1105 is now alone in its hierarchy, the representation of the hierarchy using hierarchical intersections can be deleted.

FIG. 16 shows the hierarchy of FIG. 15 with base 1205 modified to have base 1305 as its parent. Representation 1315 is modified again, with hierarchical intersection 1605 indicating that base 1305 is the parent in the relationship with base 1205. Further, the left and right visit numbers of hierarchical intersections 1605, 1610, and 1615 are modified to reflect the change in the structure of the hierarchy.

While FIGS. 4-16 show the development of hierarchies involving instances of a base, it is important to note that a single instance can be a member of multiple hierarchies. This concept embraces not only the multiple representations of a single hierarchy as it develops over time (as shown in the drawings), but also that a single instance can be a member of multiple different hierarchies that are otherwise unrelated. For example, an employee in a company can be represented by an instance of a base. This employee can be part of a hierarchy that reflects the structure of the employees in the department. But the employee can also be part of a hierarchy that represents who is working on a particular project. Since the employee might be participating in multiple different projects, the employee could be in multiple different hierarchies at the same time. The traditional recursive approach to hierarchies cannot achieve this result, because the information stored in the database can assign a single row in the table to at most one hierarchy. Further, these different hierarchies can involve different groups of instances, and can have different roots (i.e., different instances can be considered to be at the top of each hierarchy).

FIG. 17 shows the hierarchy of FIG. 7 in an alternative format that might make it easier to see how the hierarchy is represented and how the left and right visit numbers are generated. Recall that FIG. 7 first established a hierarchy with four bases. In FIG. 17, base 410, 505, 605, and 705 are shown (the respective controls are omitted from FIG. 17 for clarity). Hierarchical intersections 515, 520, 615, and 715 act as representations of the links between the bases in their various parent/child relationships. As base 410 is the root of the hierarchy, hierarchical intersection 515 represents this fact. As discussed above with reference to FIG. 5, the use of hierarchical intersection 515 to represent that base 410 is the root of the hierarchy is not required, but has benefits. In a similar manner, hierarchical intersections 520, 615, and 715 represent the parent/child relationships between bases 410 and 505, 505 and 605, and 410 and 705, respectively.

FIG. 17 might also make it easier to understand how the left and right visit numbers are assigned to the hierarchical intersections. As discussed above, the left and right visit numbers can be thought of as calculated based on a depth first search of the tree. Starting at the top, the first hierarchical intersection encountered is hierarchical intersection 515. So, hierarchical intersection 515 is assigned a left visit number of 1. The next hierarchical intersection encountered is hierarchical intersection 520, so it is assigned a left visit number of 2. Then the left visit number of hierarchical intersection 615 is assigned the number 3, the right visit number of hierarchical intersection 615 is assigned the number 4, and so on.

Similar to how FIG. 17 is an alternative representation of the hierarchy represented in FIG. 7, FIG. 18 is an alternative representation of the hierarchy represented in FIG. 15. In the hierarchy of FIG. 15, base 805 is the root of the hierarchy, and has three children: bases 1305, 1205, and 705. Thus, hierarchical intersections 1320, 1510, 1505, and 1515 represent the parent/child relationships between the bases.

Although not shown or discussed above, the database can also include information about a visit level. The visit level of a hierarchical intersection can be thought of as the depth of a particular instance in the hierarchy. Thus, for example, in FIG. 17, hierarchical intersection 515 has a visit level of 1, hierarchical intersections 520 and 715 have a visit level of 2, and hierarchical intersection 615 has a visit level of 3. Visit levels enable the database to answer questions about what instances are at a particular level: all that is required is to identify the hierarchical intersections with a particular visit level.

As compared with the standard intersection described in U.S. Pat. No. 6,768,984, issued Jul. 27, 2004, titled “METHOD AND APPARATUS FOR PROCESS DESIGN”, U.S. Pat. No. 7,254,954, issued Aug. 7, 2007, titled “METHOD AND APPARATUS FOR PROCESS DESIGN”, U.S. Pat. No. 7,756,914, issued Jul. 13, 2010, titled “METHOD AND APPARATUS FOR PROCESS DESIGN”, and U.S. Pat. No. 7,945,599, issued May 17, 2011, titled “METHOD AND APPARATUS FOR PROCESS DESIGN”, hierarchical intersections can include five elements that are not included in the standard intersection. These are the revision applicability indicator, the left and right visit levels, the visit ID, and the visit level.

Using hierarchical intersections makes it easy to answer various queries that are either difficult or impossible to answer using the traditional recursive solution to hierarchies. For example:
To find all descendants of a particular hierarchical intersection, the system only needs to identify the hierarchical intersections in the database that have left and right visit numbers between the left and right visit numbers of the selected hierarchical intersection. If the objective is to identify the immediate children of the selected hierarchical intersection, the query can be modified to also specify that the identified hierarchical intersections have a visit level 1 greater than the visit level of the particular hierarchical intersection. For example, in FIG. 17, the only descendant of hierarchical intersection 520 is hierarchical intersection 615, because hierarchical intersection 615 is the only hierarchical intersection with left and right visit numbers between 2 and 5 (the left and right visit numbers of hierarchical intersection 520).
To find all ancestors of a particular hierarchical intersection, the system only needs to identify the hierarchical intersections in the database that have a left visit number less than the left visit number of the selected hierarchical intersection and a right visit number greater than the right visit number of the selected hierarchical intersection. If the objective is to identify the immediate parent of the selected hierarchical intersection, the query can be modified to also specify that the identified hierarchical intersections have a visit level 1 less than the visit level of the particular hierarchical intersection. For example, in FIG. 17, the only ancestor of hierarchical intersection 520 is hierarchical intersection 515, because hierarchical intersection 515 is the only hierarchical intersection with a left visit number less than 2 (the left visit number of hierarchical intersection 520) and a right visit number greater than 5 (the right visit number of hierarchical intersection 520).
To find the top of the hierarchy, the system only needs to identify the hierarchical intersection in the database with a visit level of 1. Alternatively, the system can find the top of the hierarchy by identifying the hierarchical intersection with a left visit number of 1. For example, in FIG. 17, hierarchical intersection 515 is the top of the hierarchy.
To find the hierarchical intersections at the bottom of the hierarchy, the system only needs to identify the hierarchical intersections such that the right visit number is 1 greater than the left visit number. For example, in FIG. 17, hierarchical intersections 615 and 715 are at the bottom of the hierarchy, because their right visit numbers are each 1 greater than their left visit numbers.

FIG. 19 shows a flowchart of a procedure for managing a hierarchy of base instances using hierarchical intersections in the system of FIG. 2, according to an embodiment of the invention. In FIG. 19, at block 1905, the system receives a hierarchy of instances. As discussed above, the instances can be of any archetype/type in the database, and are not limited to instances of bases. At block 1910, the hierarchy of instances can be represented using hierarchical intersections. At block 1915, the system can receive a change in the hierarchy of instances: for example, changing a revision status of one of the instances, changing an instance to have a different parent or child relationship, or deleting an instance, among other possibilities. At block 1920, the representation of the hierarchy using the hierarchical intersections is duplicated, and at block 1925 the duplicated hierarchical intersections are modified to reflect the change.

FIGS. 20A-20C show details of how a duplicated hierarchical intersection can be modified at block 1925 in the flowchart of FIG. 19, depending on the change made to the hierarchy of base instances. In FIG. 20A, at block 2005, a new hierarchical intersection can be added to the representation of the hierarchy of instances. Alternatively, at block 2010, a hierarchical intersection that refers to a particular instance as a child is identified, and at block 2015 the hierarchical intersection is modified to reflect a different parent for the child instance.

Alternatively, at block 2020 (in FIG. 20B), an old hierarchical intersection can be deleted. Then, at block 2025, the system can identify any orphaned instances in the hierarchy. If any orphaned instances are identified, then at block 2030 a hierarchical intersection including the orphaned instance can be identified. At block 2035, the identified hierarchical intersection can be deleted, and at block 2040 the orphaned instance be removed from the hierarchy of instances.

Alternatively, at block 2045 (FIG. 20C), the system can identify a hierarchical intersection that includes an instance as a child. Then, at block 2050, the revision status of the hierarchical intersection can be modified to reflect a change in the revision status of the instance.

Another possible modification to a duplicated hierarchy can be when an instance is moved from one hierarchy to another. But this modification is functionally equivalent to deleting the instance from its original hierarchy, and adding the instance in its new hierarchy. Thus, moving an instance from one hierarchy to another is effectively shown in FIGS. 20A-20C as including a combination of blocks 2005, 2020, 2025, 2030, 2035.

FIG. 21 shows details of how duplicated hierarchical intersections can be deleted if no hierarchical intersection representing a hierarchy of instances has its applicability indicator set, according to an embodiment of the invention. In FIG. 21, at block 2105, a hierarchy is selected. At block 2110, the hierarchical intersections representing the hierarchy are examined. If no hierarchical intersection representing the hierarchy has its applicability indicator set, then at block 2115, the hierarchical intersections representing the hierarchy can be deleted.

The flowcharts described above are exemplary embodiments of how the procedures described therein can be implemented. Embodiments of the invention can include additional blocks, or can remove blocks, as appropriate. In addition, the order of the blocks shown can vary as appropriate.

The above discussion describes the use of hierarchical intersections to manage hierarchies involving instances of a single base. In such situations, all the records are part of a single table. But it is also possible to have hierarchical intersections manage hierarchies that involve instances of different bases. Since different bases can be stored in different tables, the hierarchical intersections can relate information across different tables. To distinguish between these two possibilities, hierarchical intersections that involve instances of a single base are termed homogeneous, and hierarchical intersections that involve instances of multiple bases are termed heterogeneous. Because databases can only use foreign keys that point to a single table, heterogeneous hierarchical intersections cannot be directly used within the database programming language. But it is possible to access the information using the foreign key, “jump out” of the database programming language, then “re-enter” the database programming language, using the information to construct an appropriate query to access the instances.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, any of the Institute of Electrical and Electronics Engineers (IEEE) 810.11 standards, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other non-transitory storage devices and their associated storage media, including hard-drives, floppy-disks, optical storage, tapes, flash memory, memory sticks, digital video disks, biological storage, etc.: such associated data, by virtue of being stored on a storage medium, does not include propagated signals. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And, though the foregoing discussion has focused on particular embodiments, other configurations are contemplated. In particular, even though expressions such as “in one embodiment” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. An apparatus, comprising:
a computer, including a memory;
a database stored in the memory;
a type stored in the database;
a hierarchy of instances of the type stored in the database, each instance in the hierarchy including information about an object in a process design;
a plurality of hierarchical intersections stored in the database, the plurality of hierarchical intersections representing the hierarchy of instances of the type; and
a modifier to modify the plurality of hierarchical intersections responsive to a change in the hierarchy of instances of the type, the modifier operative to duplicate the plurality of hierarchical intersections and to modify at least one of the duplicated plurality of hierarchical intersections.

2. An apparatus according to claim 1, wherein:
the type includes a base; and
the hierarchy of instances of the type stored in the database, includes a hierarchy of instances of the base stored in the database.

3. An apparatus according to claim 2, wherein the modifier is operative to add a new hierarchical intersection to the duplicated plurality of hierarchical intersections responsive to the addition of a new instance of the base to the hierarchy of instances of the base.

4. An apparatus according to claim 2, wherein the modifier is operative to delete an old hierarchical intersection from the duplicated plurality of hierarchical intersections responsive to the deletion of an old instance of the base from the hierarchy of instances of the base.

5. An apparatus according to claim 4, wherein the modifier is further operative to identify an orphaned instance in the hierarchy of instances, identify at least one hierarchical intersection in the duplicated hierarchical intersections that includes the orphaned instance, and remove the at least one hierarchical intersection in the duplicated hierarchical intersections that includes the orphaned instance.

6. An apparatus according to claim 5, wherein the modifier is further operative to remove the at least one orphaned instance from the hierarchy of instances.

7. An apparatus according to claim 4, wherein the modifier is operative to delete the plurality of hierarchical intersections representing the hierarchy of instances if no hierarchical intersection in the plurality of hierarchical intersections representing the hierarchy of instances has its applicability indicator set.

8. An apparatus according to claim 2, wherein the modifier is operative to identify a hierarchical intersection in the duplicated plurality of hierarchical intersections that includes the a first instance as a child instance and a second instance as a parent instance and to modify the identified hierarchical intersection in the duplicated plurality of hierarchical intersections to include a third instance as a parent instance responsive to the first instance being relocated from a child of the second instance to a child of the third instance.

9. An apparatus according to claim 2, wherein the modifier is operative to identify a hierarchical intersection in the duplicated plurality of hierarchical intersections that includes an instance as a child instance and change a revision status of the identified hierarchical intersection in the duplicated plurality of hierarchical intersections responsive to a change in a revision status for the instance in the hierarchy of instances.

10. An apparatus according to claim 2, wherein each hierarchical intersection in the plurality of hierarchical intersections identifies pairs of instances, the pair of instances including a first instance is a parent instance and a second instance is a child instance.

11. An apparatus according to claim 10, wherein each hierarchical intersection in the plurality of hierarchical intersections further includes a visit identifier, a left visit identifier, and a right visit identifier.

12. An apparatus according to claim 11, wherein each hierarchical intersection in the plurality of hierarchical intersections further includes a visit level.

13. A method, comprising:
creating a hierarchy of instances of a type in a computer, wherein the hierarchy of instances is represented using hierarchical intersections between pairs of instance s, and in each pair of instance s, a first instance is a parent instance and a second instance is a child instance;
receiving a change to the hierarchy of instances;
duplicating the hierarchical intersections that represent the hierarchy of instances; and
modifying one of hierarchical intersections in the duplicate hierarchical intersections responsive to the change to the hierarchy of instances.

14. A method, according to claim 13, wherein creating a hierarchy of instances of a type in a computer includes creating the hierarchy of instances of a base.

15. A method according to claim 14, wherein:
receiving a change to the hierarchy of instances includes receiving an addition of a new instance of the base to the hierarchy of instances; and
modifying one of hierarchical intersections responsive to the change to the hierarchy of instances includes adding a new hierarchical intersection to the duplicate hierarchical intersections to represent that the new instance of the base is a child instance and another instance is a parent instance.

16. A method according to claim 14, wherein:
receiving a change to the hierarchy of instances includes receiving a deletion of an instance from the hierarchy of instances; and
modifying one of hierarchical intersections responsive to the change to the hierarchy of instances includes deleting a hierarchical intersection from the duplicate hierarchical intersections.

17. A method according to claim 16, wherein modifying one of hierarchical intersections responsive to the change to the hierarchy of instances further includes:
identifying at least one orphaned instance in the duplicate hierarchy of instances;
identifying at least one hierarchical intersection including the at least one orphaned instance;
deleting the at least one hierarchical intersection including the at least one orphaned instance; and
removing the at least one orphaned instance from the duplicate hierarchy of instances.

18. A method according to claim 16, wherein modifying one of hierarchical intersections responsive to the change to the hierarchy of instances further includes deleting the hierarchical intersections representing the hierarchy of instances if no hierarchical intersections has its applicability indicator set.

19. A method according to claim 14, wherein:
receiving a change to the hierarchy of instances includes receiving a relocation of a first instance in the hierarchy of instances, wherein the first instance had been a child of a second instance and is to be a child of a third instance; and
modifying one of hierarchical intersections responsive to the change to the hierarchy of instances includes:
identifying a hierarchical intersection including the second instance as a parent instance and the first instance as a child instance; and
modifying the hierarchical intersection to include the third instance as a parent instance and the first instance as a child instance.

20. A method according to claim 14, wherein:
receiving a change to the hierarchy of instances includes receiving a change of a revision status for an instance in the hierarchy of instances; and
modifying one of hierarchical intersections responsive to the change to the hierarchy of instances includes:
identifying a first hierarchical intersection in the hierarchical intersections for which the instance being changed is a child instance; and
changing a revision status of the first hierarchical intersection to match the revision status of the instance in the hierarchy of instances.

21. A method according to claim 14, wherein creating a hierarchy of instances of a base includes creating the hierarchy of instances of the base, wherein the hierarchy of instances is represented using hierarchical intersections between pairs of instances, and in each pair of instances, a first instance is a parent instance and a second instance is a child instance, each hierarchical intersection including a visit identifier, a left visit identifier, and a right visit identifier.

22. A method according to claim 21, wherein creating a hierarchy of instances of a base further includes creating the hierarchy of instances of the base, wherein the hierarchy of instances is represented using hierarchical intersections between pairs of instances, and in each pair of instances, a first instance is a parent instance and a second instance is a child instance, each hierarchical intersection further including a visit level.

23. An article, comprising a non-transitory storage medium, said non-transitory storage medium having stored thereon instructions that, when executed by a machine, result in:
creating a hierarchy of instances of a type in a computer, wherein the hierarchy of instances is represented using hierarchical intersections between pairs of instance s, and in each pair of instance s, a first instance is a parent instance and a second instance is a child instance;
receiving a change to the hierarchy of instances;
duplicating the hierarchical intersections that represent the hierarchy of instances; and
modifying one of hierarchical intersections in the duplicate hierarchical intersections responsive to the change to the hierarchy of instances.

24. An article, according to claim 23, wherein creating a hierarchy of instances of a type in a computer includes creating the hierarchy of instances of a base.

25. An article according to claim 24, wherein:
receiving a change to the hierarchy of instances includes receiving an addition of a new instance of the base to the hierarchy of instances; and
modifying one of hierarchical intersections responsive to the change to the hierarchy of instances includes adding a new hierarchical intersection to the duplicate hierarchical intersections to represent that the new instance of the base is a child instance and another instance is a parent instance.

26. An article according to claim 24, wherein:
receiving a change to the hierarchy of instances includes receiving a deletion of an instance from the hierarchy of instances; and
modifying one of hierarchical intersections responsive to the change to the hierarchy of instances includes deleting a hierarchical intersection from the duplicate hierarchical intersections.

27. An article according to claim 26, wherein modifying one of hierarchical intersections responsive to the change to the hierarchy of instances further includes:
identifying at least one orphaned instance in the duplicate hierarchy of instances;
identifying at least one hierarchical intersection including the at least one orphaned instance;
deleting the at least one hierarchical intersection including the at least one orphaned instance; and
removing the at least one orphaned instance from the duplicate hierarchy of instances.

28. An article according to claim 26, wherein modifying one of hierarchical intersections responsive to the change to the hierarchy of instances further includes deleting the hierarchical intersections representing the hierarchy of instances if no hierarchical intersections has its applicability indicator set.

29. An article according to claim 24, wherein:
receiving a change to the hierarchy of instances includes receiving a relocation of a first instance in the hierarchy of instances, wherein the first instance had been a child of a second instance and is to be a child of a third instance; and
modifying one of hierarchical intersections responsive to the change to the hierarchy of instances includes:
identifying a hierarchical intersection including the second instance as a parent instance and the first instance as a child instance; and
modifying the hierarchical intersection to include the third instance as a parent instance and the first instance as a child instance.

30. An article according to claim 24, wherein:
receiving a change to the hierarchy of instances includes receiving a change of a revision status for an instance in the hierarchy of instances; and
modifying one of hierarchical intersections responsive to the change to the hierarchy of instances includes:
identifying a first hierarchical intersection in the hierarchical intersections for which the instance being changed is a child instance; and
changing a revision status of the first hierarchical intersection to match the revision status of the instance in the hierarchy of instances.

31. An article according to claim 24, wherein creating a hierarchy of instances of a base includes creating the hierarchy of instances of the base, wherein the hierarchy of instances is represented using hierarchical intersections between pairs of instances, and in each pair of instances, a first instance is a parent instance and a second instance is a child instance, each hierarchical intersection including a visit identifier, a left visit identifier, and a right visit identifier.

32. An article according to claim 31, wherein creating a hierarchy of instances of a base further includes creating the hierarchy of instances of the base, wherein the hierarchy of instances is represented using hierarchical intersections between pairs of instances, and in each pair of instances, a first instance is a parent instance and a second instance is a child instance, each hierarchical intersection further including a visit level.
